(19) United States
(12) Patent Application Publication
(10) Pub. No.: US 2016/0023668 A1
(43) Pub. Date: Jan. 28, 2016

(54) SPEED ENHANCING SYSTEM USING A MOVING BASE

(71) Applicant: Shishir SHETTY, Karnataka (IN)

(72) Inventor: Shishir Shetty, Mangalore (IN)

(21) Appl. No.: 14/774,744

(22) PCT Filed: Mar. 10, 2014
(86) PCT No.: PCT/IN2014/000154

§ 371 Date: Sep. 11, 2015

(30) Foreign Application Priority Data
Mar. 12, 2013 (IN) 1045/CHE/2013

(51) Int. Cl. B61B 13/00; B65G 49/00

(52) U.S. Cl. CPC B61B 13/00; B65G 49/00

(57) ABSTRACT

The present invention deals with speed enhancing train system comprising of basic railway track (Track 1) between two desired destinations (A, B) and a train engine (EI) on the said track with an attached platform having wheels and being parallel to the basic railway track and having a track (Track 2) running throughout its length. The preferred length of the said platform with the track is two third of the total distance between the two desired destinations. A second train engine (E2) with attached coaches capable of running on the tracks (Track 2) on the platform, attached to the first engine. As both the engines run in the same direction the total speed achieved is additive and greatly enhanced.

### BACKGROUND OF THE INVENTION

Ever increasing population, urban agglomeration, and emergence of new cities have created a demand for mass transportation system through surface and air and is one of the reasons why there is a continuous craving for high speed trains all over the world. To cope with the future traffic requires extra lines (tracks) have to be added in the same route or the speed of goods and passenger trains have to be increased to create more carrying capacities in the same block section. The decrease in the travel time due to enhanced speed virtually brings the cities closer.

The last century has witnessed a sudden shift of population from rural and sub-rural places to cosmopolitan and metropolitan cities for work opportunities. Unfortunately, in many cities the infrastructure has not been able to cope up with the population, hence the cities continues to grow without much planning making the city congested and thus creating a lot of chaos. In fact in most of the cities commuting to the airport would take a person more time than the actual flying time. To cope with all these, uninterrupted high speed travel is the need of the hour

All over the world high speed train means a train running at a speed more than 250 kmph and this speed has been achieved gradually and over a period of time—mainly due to advancement in technology. In order to achieve higher speed, there is a need to develop improvements in the infrastructures—particularly in the track system. Continuous welded rail is generally used to reduce track vibrations and misalignment. Almost all high-speed lines are electrically driven via overhead cables, have in-cable signaling.

Many countries in addition to Japan have developed high-speed rail to connect major cities (e.g. China, France, Germany, Italy, Taiwan, Turkey, South Korea and Spain). As of 2012 the maximum commercial speed on most high-speed rail lines was about 300 km/h (185 mph).

Japan's latest bullet train uses magnetic levitation to make it the fastest train in the world, reaching speeds of 310 miles per hour. Powerful magnets will float the train just above the track to reduce friction and increase speed.

All the research is focused on developing high speed engines which are highly expensive and involves a lot of research and development

With all the research and advancements made in this area of “high speed trains’—there is a limit beyond which the speed of the train cannot be increased at the present level of technology. Hence there is a need to exploit other methods which can substantially increase the speed of travelling by train.

### OBJECTS OF THE INVENTION

The main object of the present invention is to increase the speed of train or any other movable units by using methods other than increasing the speed of the Engine per se—.

Another object of the invention is to use the moving platform for enhancing the speed of any other system/device/instrument. The above objectives have been achieved by designing a moving platform with tracks which moves on the same direction—on which the train or other movable units move. Hence the speed of the train or other movable is substantially increased.

### BRIEF DESCRIPTION OF THE DRAWINGS

The aspects of the invention, its nature, and various features will become more apparent upon consideration of the following detailed description, taken in conjunction with the accompanying drawings

FIG. 1 is a diagrammatic view of speed enhancing train system: having—A metallic Track 1 i.e Basic track from the point of origin ‘A’ to the point of destination ‘B’. Engine E1 with metal wheels will be placed on top of Track 1. A long metal platform with metal wheels almost two thirds the length of Track 1 is attached to Engine E1. The platform attached to the Engine 1, has to its entire length another metal track i.e. Track 2. On top of Track 2 at point ‘A’, another engine with metal wheels is be placed. i.e. Engine E2 which will also comprise of coaches or carrying means for people or things—such that it can move along the length of Track 2.

FIG. 2 depicts the relative positions of the Engine El and Engine E2 when the Engine E1 with the attached Track 2 reaches the destination B

In the FIG. 3: 1—Denotes Track 1 2—Denotes Track 2 3—Denotes Track 3 4—Denotes Track 4 5—Denotes Track 6

### DETAILED DESCRIPTION OF THE INVENTION

The present invention comprises of a system for enhancing the speed of the Train travel will basically have two tracks, one on top of the other and two engines. The speed of the train moving on the top track will have the speed of its engine plus the speed of the below engine. Thus enabling the train to move faster and cover more distance in less time.

The said model will consist of a metallic track (Track 1) similar to a railway track from the point of origin ‘A’ to the point of destination ‘B’. An engine (Engine 1) with metal wheels will be placed on top of Track 1. To the Engine 1 (E1) is attached to a long metal platform almost 60% of the length of Track 1. The metal platform will have metal wheels and will also be on top of Track 1, such that it can be moved along the length of Track 1.

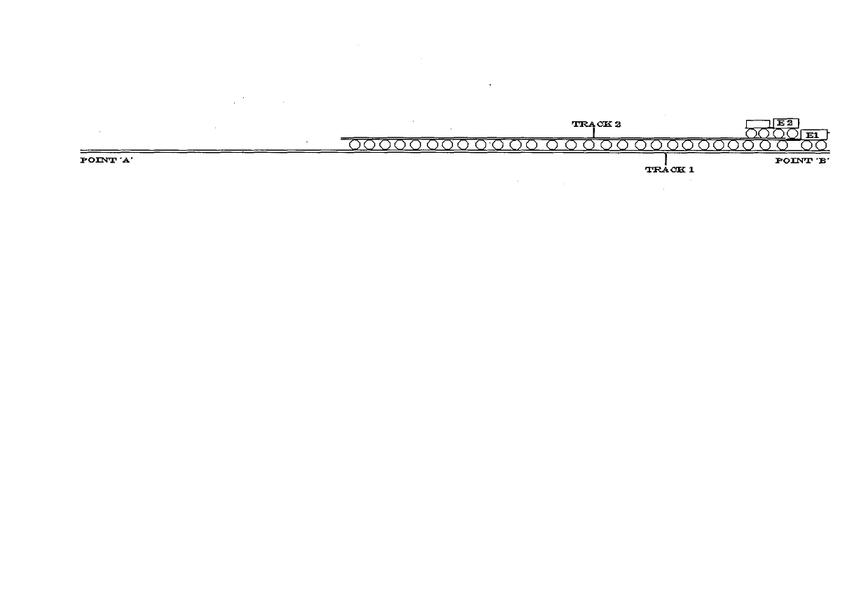

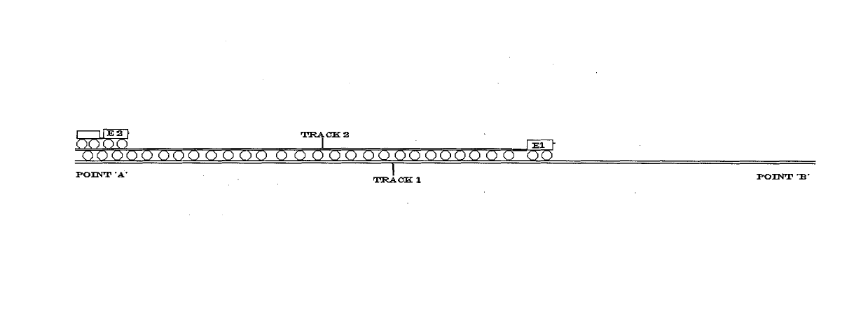

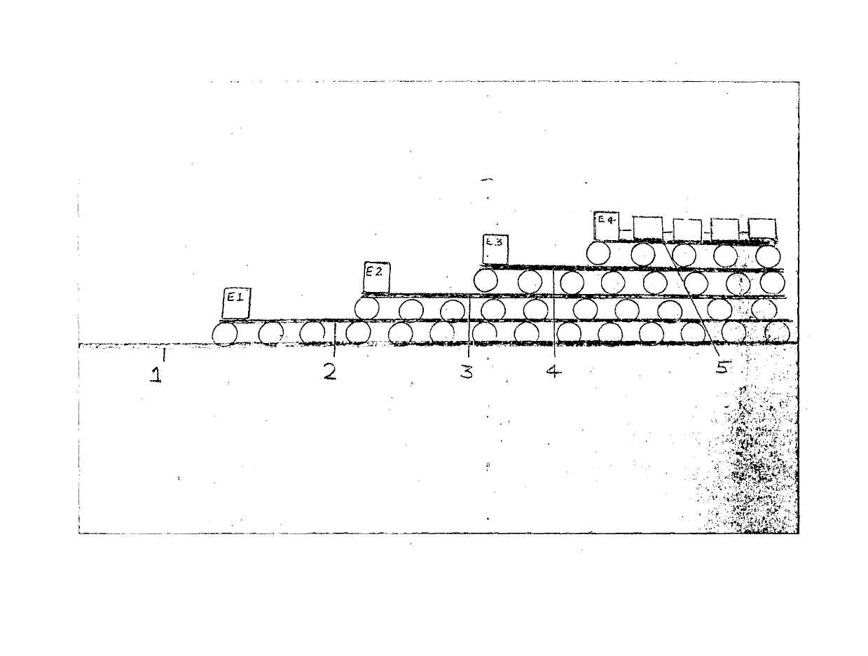

Over the platform, to its entire length there will be another metal track (Track 2) similar to the track 1. On top of track 2 at point ‘A’, an Engine (Engine 2) with metal wheels will be placed which will also comprise of bogies such that it can move along the length of track 2. At a given time simultaneously Engine 1 (E1) and Engine 2 (E2) will move towards point B such that by the time Engine 2 reaches the end of the track 2, the Engine 1 would have reached the end of track 1 which is point B. (FIGS. 1 & 2)

The ‘platform’ used in the specification and claims is to be understood as in the common usage—‘a flat means parallel to the ground to support’ any means including a track system.

There can be some modifications to this—which also works with added advantages.
Instead of just 2 tracks and 2 engines, multiple tracks and engines are to be placed one on top of the other. (FIG. 3)

The speed enhancing system wherein the tracks on the platforms consist of multiple units arranged closed to each other to form a continuous track instead of a single long unit to enable the moving units on the platforms to negotiate a curvature

There can be different embodiments based on the concept and example described above

### EXAMPLE

A speed enhancing system comprising of a basic track system covering the distance between two points of desired length and a moving means on basic track system—with a platform having a track system parallel to the basic track system attached to its rear end. The length of the said platform is preferably two third of the basic track system. A second moving means with desired attachments or means for carrying would move on the track system of the platform attached to the first moving means. The speed of the second moving means is considerably increased on account of the moving base—i.e when the second moving means with the platform with tracks moves on the basic track system in the same forward direction. The total speed speed is additive

There can be multiple moving means and the tracks as shown in FIG. 3 one above the other—to enhance the speed of particularly upper most moving parts with relevant desired attachments.

In another embodiment the track system is dispensed with allowing the moving means to move in non defined pathway.

Such speed enhancing systems can be used for multiple tasks such as transferring the luggage's from the aircraft to terminus, in baggage carousels or in construction activities for transferring materials from one point to the others or in ‘moving walkway’ or ‘moving sidewalk’; colloquially sometimes referred as ‘horizontalator’, ‘travelator’ i.e a slow moving conveyor mechanism that transport people across a horizontal or inclined plane over a short to medium distance. Moving walkways can be used by standing or walking on them.

In the specification the word “platform’ has the meaning of a flat sheet like part made up of a strong material, preferably rectangular capable of supporting the desired objects.

In fact the concept and technology of the present invention can be applied to a broad category of the moving units, machines, implements etc—wherein the speed of the same is doubled by just providing a moving platform/base (in the same direction as the moving unit).

The invention described above may be embodied in other specific forms without departing from the spirit and essential characteristics thereof and without undue experimentation. The present embodiments are to be considered in all respects as illustrative and not restrictive.

1. A speed enhancing train system comprising of basic railway track between two desired destinations, a train engine on the said track with an attached platform having wheels and being parallel to the basic railway track and having a track running throughout its length, the length of the said platform with the track being two third of the total distance between the two desired destinations, a second train engine with attached coaches capable of running on the tracks on the platform attached to the first engine.

2. The speed enhancing system according to claim 1, wherein the tracks are made up of metal preferably steel.

3. The speed enhancing system according to claim 1 wherein the wheels are made up of metal preferably steel.

4. The speed enhancing system according to claim 1, wherein there are plurality of engines with attached platforms having tracks approximately two third of the length of the lower platform placed one above the other with the engine having coaches on the top most platform.

5. The speed enhancing system according to claim 1, wherein the tracks on the platforms consist of multiple units arranged closed to each other to form a continuous track instead of a single long unit to enable the moving units on the platforms to negotiate a curvature

6. A speed enhancing system comprising of a basic track system covering the distance between two points of desired length, a moving means with a platform having a track system parallel to the basic track system attached to its rear end, the length of the said platform being two third of the basic track system, and a second moving means with desired attachments moving on the track system of the platform attached to the first moving means.

7. The speed enhancing system according to claim 6, wherein there are plurality of moving means with attached platforms having tracks approximately two third of the length of the lower platform placed one above the other with the moving means having desired attachments on the top most platform.

8. The speed enhancing system according to claim 6, wherein the tracks on the platforms consist of multiple units arranged closed to each other to form a continuous track instead of a single long unit to enable the moving units on the platforms to negotiate a curvature

9. The speed enhancing system according to claim 6, wherein the moving means are engines capable of pulling the platforms or attachments.

10. The speed enhancing system as per claim 6, for use in baggage carousel

11. The speed enhancing system as per claim 6, for use in transporting heavy construction material like prefabricated beams to the construction site.

12. A speed enhancing system for moving between 2 points comprising a moving means with a platform parallel to the floor attached to its rear end, the length of the said platform being two third of distance between the said two points, and a second moving means with desired attachments having carrying means moving on platform attached to the first moving means.

13. The speed enhancing system according to claim 12, wherein there are plurality of moving means with attached platforms approximately two third of the length of the lower platform placed one above the other with the moving means having—carrying means on the top most platform.

14. The speed enhancing system as per claim 12, for use in baggage carousel
